(19) United States
(12) Patent Application Publication
(10) Pub. No.: US 2014/0218243 A1
(43) Pub. Date: Aug. 7, 2014

(54) COMMUNICATION DEVICE WITH TUNABLE GROUND PLANE ANTENNA ELEMENT

(71) Applicant: ACER INCORPORATED, New Taipei City (TW)

(72) Inventors: Kin-Lu Wong, Kaohsiung City (TW); Meng-Ting Chen, Kaohsiung City (TW)

(73) Assignee: ACER INCORPORATED, New Taipei City (TW)

(21) Appl. No.: 13/802,772

(22) Filed: Mar. 14, 2013

(30) Foreign Application Priority Data
Feb. 4, 2013 (TW) 102104260

(51) Int. Cl. H01Q 1/50; H01Q 9/06

(52) U.S. Cl. CPC H01Q 1/50; H01Q 9/065
USPC 343/700 MS

(57) ABSTRACT

A communication device including a ground element and an antenna element is provided. The ground element has a first edge and a second edge, wherein the first edge is substantially perpendicular to the second edge. The antenna element is disposed adjacent to the first edge of the ground element. The ground element is coupled to a circuit module. The circuit module includes at least two reactive circuits, such that the antenna element is selectively operated in a first band or a second band. The antenna element and the ground element form an unsymmetrical dipole antenna structure. The longest current path length of the antenna element is less than 0.3 times the length of the second edge.

### CROSS-REFERENCE TO RELATED APPLICATION

This application claims the priority benefit of Taiwan application serial no. 102104260, filed on Feb. 4, 2013. The entirety of the above-mentioned patent application is hereby incorporated by reference herein and made a part of this specification.

### BACKGROUND

1. Field of the Invention

The present invention is directed to a communication device and more particularly, to a communication device having an adjustable ground plane antenna element.

2. Description of Related Art

In recent years, consumers' demands on functions of mobile communication devices have become gradually increased, and the development of the functions of these products has become faster and faster. Mobile communication services added to the calling function mean that additional elements have to be added in the communication devices for providing the related functions. However, with the development trend of slim-type communication devices, how to utilize limited space to design an antenna and achieve better performances than the traditional antenna has become a very challenging subject.

### SUMMARY

The present invention provides a communication device for an antenna element to be operated in multiple bands to cover LTE/WWAN bands.

The communication device of the present invention includes a ground element and an antenna element. The ground element has a first edge and a second edge, wherein the first edge is substantially perpendicular to the second edge. The antenna element is disposed adjacent to the first edge of the ground element, and the antenna element is coupled to a circuit module. The circuit module includes at least two reactive circuits, such that the antenna element may be operated in a first band or a second band. The antenna element and the ground element forms an unsymmetrical dipole antenna structure, and a longest current path length of the antenna element is less than 0.3 times a length of the second edge.

To sum up, the present invention provides a communication device having an adjustable ground plane antenna element, such that the antenna element may achieve the multi-band operation under the condition where the antenna element is maintained in a small size to solve the issue that the space available for designing an antenna element is very limited. In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the operating principles of the present invention.

FIG. 1 is a structural schematic diagram showing a communication device according to the first embodiment of the present invention.

FIG. 2 is a chart showing return loss when the antenna element is coupled to the first reactive circuit according to the first embodiment of the present invention.

FIG. 3 is a chart showing return loss when the antenna element is coupled to the second reactive circuit according to the first embodiment of the present invention.

FIG. 4 is a chart showing antenna efficiency when the antenna element is coupled to the first reactive circuit according to the first embodiment of the present invention.

FIG. 5 is a chart showing antenna efficiency when the antenna element is coupled to the second reactive circuit according to the first embodiment of the present invention.

FIG. 6 is a structural schematic diagram showing a communication device according to the second embodiment of the present invention.

FIG. 7 is a structural schematic diagram showing a communication device according to the third embodiment of the present invention.

FIG. 8 is a structural schematic diagram showing a communication device according to the fourth embodiment of the present invention.

### DESCRIPTION OF EMBODIMENTS

In order to make the aforementioned and other features and advantages of the present invention more comprehensible, several embodiments accompanied with figures are described in detail below.

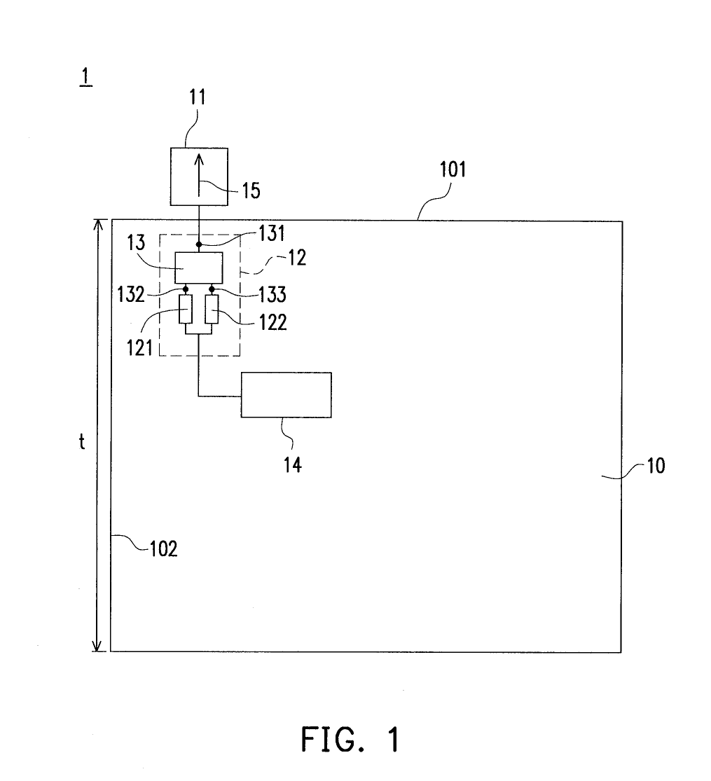

FIG. 1 is a structural schematic diagram showing a communication device according to the first embodiment of the present invention. Referring to FIG. 1, a communication device 1 includes a ground element 10, an antenna element 11 and a circuit module 12. The ground element 10 is a system ground plane of the communication device 1 and has a first edge 101 and a second edge 102. Besides, the first edge 101 is adjacent to and substantially perpendicular to the second edge 102.

The antenna element 11 is disposed adjacent to the first edge 101 of the ground element 10 and may be, for example, a rectangular metal sheet. It is to be mentioned that generally, a dipole antenna structure or a dipole-like antenna structure includes two branches with substantially the same length. However, in the embodiment illustrated in FIG. 1, the antenna element 11 and the ground element 10 form an unsymmetrical dipole antenna structure. Additionally, a longest current path length 15 of the antenna element 11 is less than 0.3 times a length t of the second edge.

The circuit module 12 is disposed above the ground element 10 and coupled to the antenna element 11. The circuit module 12 includes at least two reactive circuits. For example, the circuit module 12 includes a first reactive circuit 121 and a second reactive circuit 122. In addition, the circuit module 12 further includes a switching circuit 13. The switching circuit 13 has a first terminal 131, a second terminal 132 and a third terminal 133. The first terminal 131 of the switching circuit 13 is coupled to the antenna element 11, the second terminal 132 of the switching circuit 13 is coupled to the first reactive circuit 121, and the third terminal 133 of the switching circuit 13 is coupled to the second reactive circuit 122. During the operation, the first terminal 131 may be selectively conducted to the second terminal 132 or the third terminal 133. As such, the antenna element 11 may be selectively coupled to the first reactive circuit 121 or the second reactive circuit 122 through the switching circuit 13.

In other words, the antenna element 11 may be coupled to different reactive circuit through the switching circuit 13, such that the antenna element 11 may be operated in different bands. For instance, when the antenna element 11 is coupled to the first reactive circuit 121 through the switching circuit 13, the antenna element 11 generates at least one resonant mode to cover the first band. The first band may be, for example, a low-frequency band (approximately covering 704 MHz˜960 MHz) of the antenna element 11. When the antenna element 11 is coupled to the second reactive circuit 122 through the switching circuit 13, the antenna element 11 generates at least one resonant mode to cover the second band. The second band may be, for example, a high-frequency band (approximately covering 1710 MHz˜2690 MHz) of the antenna element 11.

It is to be mentioned that the longest current path length 15 of the antenna element 11 is only required to be less than 0.3 times a length t of the second edge 102 or less than 0.15 times a wavelength of a lowest frequency in the first band or the second band. As such, the unsymmetrical dipole antenna structure formed by the antenna element 11 and the ground element 10 may resonate in at least one band. Further, since the antenna element 11 may be coupled to different reactive circuits through the switching circuit 13, the unsymmetrical dipole antenna structure may form an adjustable ground plane antenna element so as to achieve the multi-band operation.

In addition, the communication device 1 further includes a communication module 14. The communication module 14 is coupled to the circuit module 12. For instance, the communication module 14 is coupled to the first reactive circuit 121 and the second reactive circuit 122 of the circuit module 12. Besides, the communication module 14 transmits a feeding signal to the circuit module 12 to excite the antenna element 11. In an embodiment of the present invention, the communication module 14 is configured to transmit a control signal to the switching circuit 13. Further, the switching circuit 13 is controlled by the control signal so as to selectively conduct the first terminal to the second terminal or the third terminal, but the present invention is not limited thereto.

It is to be mentioned that in an embodiment of the present invention, the antenna element 11 and the ground element 10 of the communication device 1 may be formed on the same dielectric substrate, and the dielectric substrate may be a flexible dielectric substrate. That is to say, the ground plane antenna element of the embodiment illustrated in FIG. 1 may also be applied in a flexible communication device.

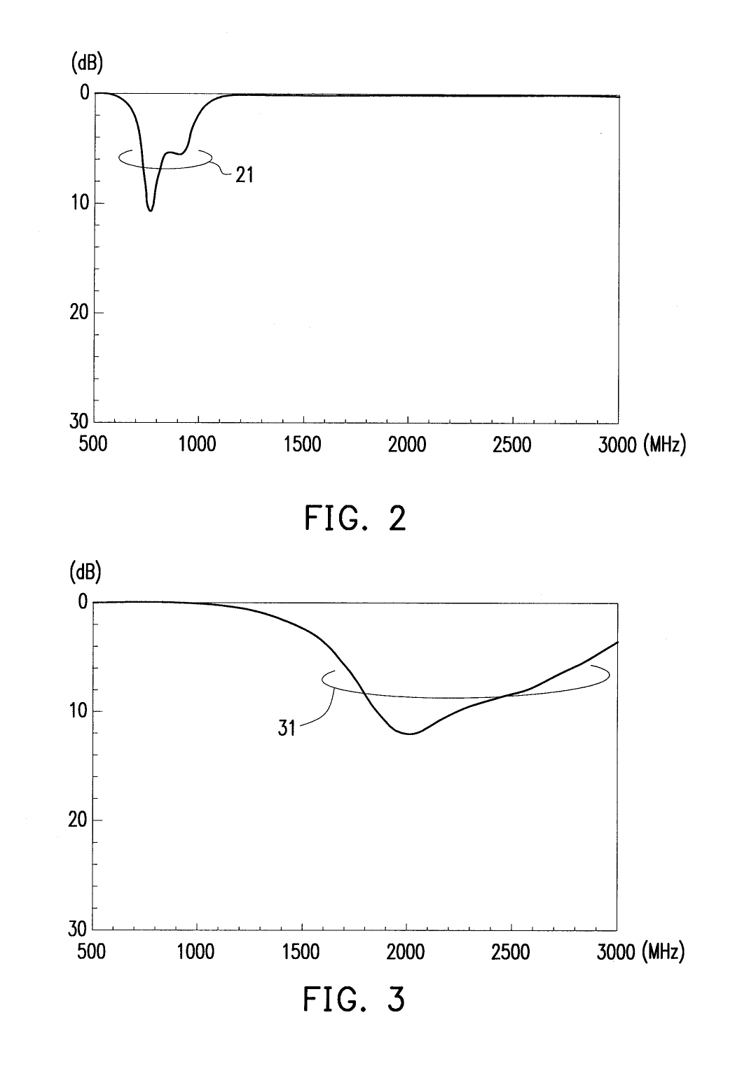

FIG. 2 is a chart showing return loss when the antenna element 11 is coupled to the first reactive circuit 121 according to the first embodiment of the present invention. In the present embodiment, a dimension of the ground element is about 100×150 mm² (which is approximately equal to a size of a ground element of a typical tablet PC), and a size of the antenna element is about 10×10 mm². Here, the antenna element 11 is coupled to the first reactive circuit 121 through the switching circuit 13, such that the antenna element 11 may be operated in a first band 21. The first band 21 covers at least one mobile communication band. For example, the first band 21 may cover LTE700/GSM850/900 bands.

FIG. 3 is a chart showing return loss when the antenna element 11 is coupled to the second reactive circuit 122 according to the first embodiment of the present invention. The antenna element 11 is coupled to the second reactive circuit 122 through the switching circuit 13, such that the antenna element 11 may be operated in a second band 31. The second band 31 covers at least one mobile communication band. For example, the second band 31 may cover GSM1800/1900/UMTS/LTE2300/2500 bands.

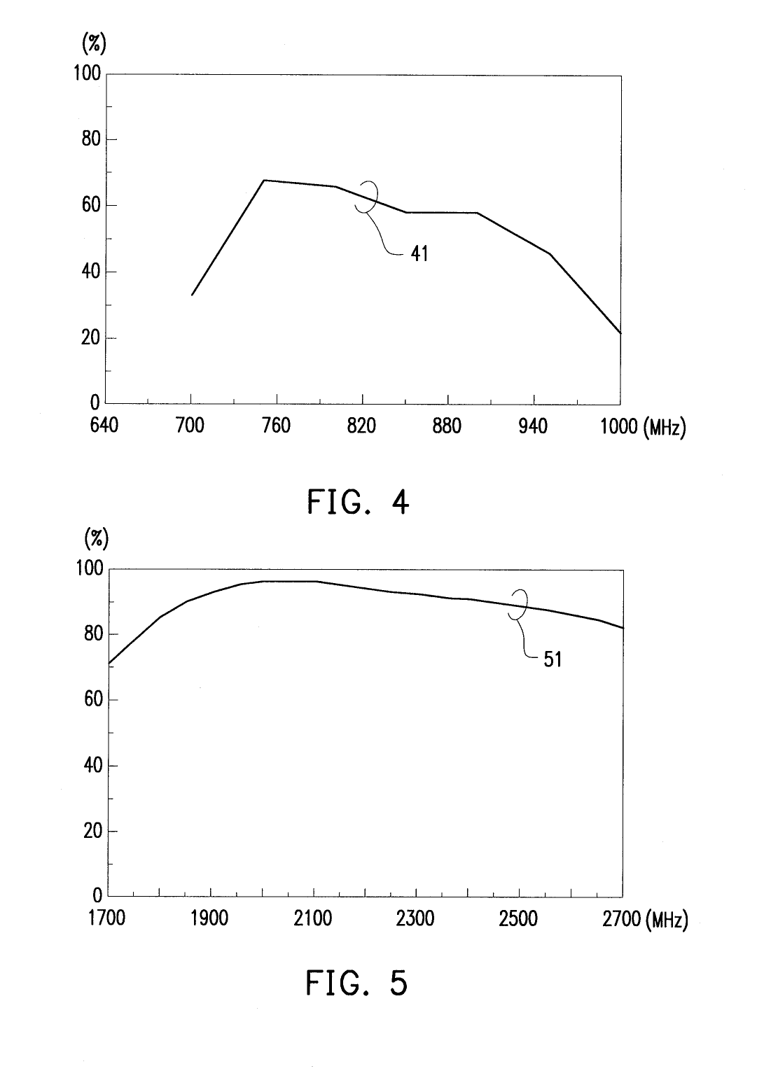

FIG. 4 is a chart showing antenna efficiency when the antenna element 11 is coupled to the first reactive circuit 121 according to the first embodiment of the present invention. An antenna efficiency curve 41 represents the antenna efficiency of the antenna element 11 in the LTE700/GSM850/900 bands, and the return losses are included in the antenna efficiency. As shown in FIG. 4, the antenna element 11 can have good antenna efficiency in the LTE700/GSM850/900 bands to meet the practical applications.

FIG. 5 is a chart showing antenna efficiency when the antenna element 11 is coupled to the second reactive circuit 122 according to the first embodiment of the present invention. An antenna efficiency curve 51 represents the antenna efficiency of the antenna element 11 in the GSM1800/1900/UMTS/LTE2300/2500 bands. As shown in FIG. 5, the antenna element 11 can have good antenna efficiency in the GSM1800/1900/UMTS/LTE2300/2500 bands to meet the practical applications.

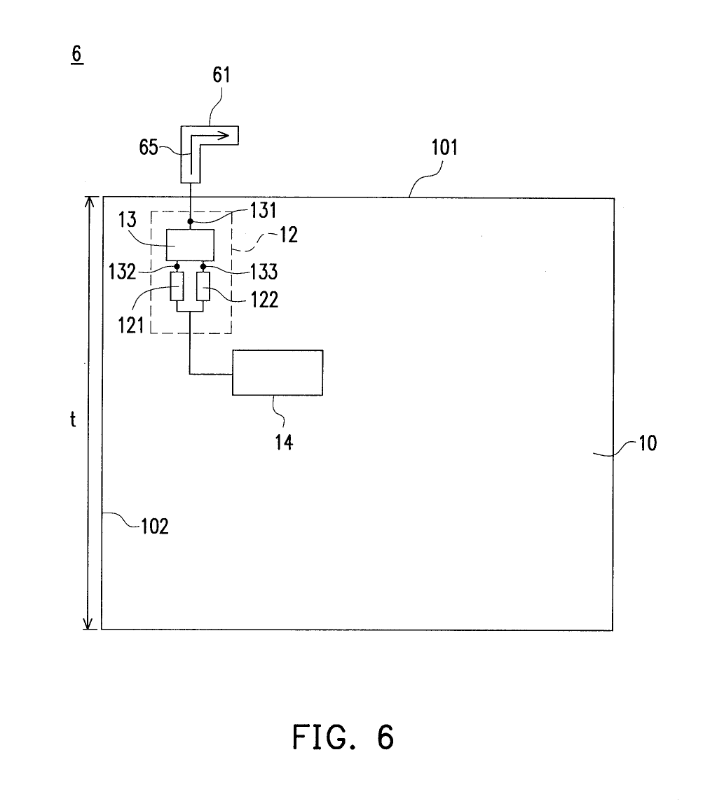

FIG. 6 is a structural schematic diagram showing a communication device according to the second embodiment of the present invention. In the second embodiment, a communication device 6 has an antenna element 61 which is an inverted L-shaped metal sheet and includes a current path 65. Additionally, the current path 65 may have at least one bend. The rest of the structure of the communication device 6 is the same as or similar to the first embodiment (i.e., the communication device 1 illustrated in FIG. 1) and will not be repeatedly described. The second embodiment has the similar structure to the first embodiment, and thus, the second embodiment can also achieve an effect similar to the first embodiment.

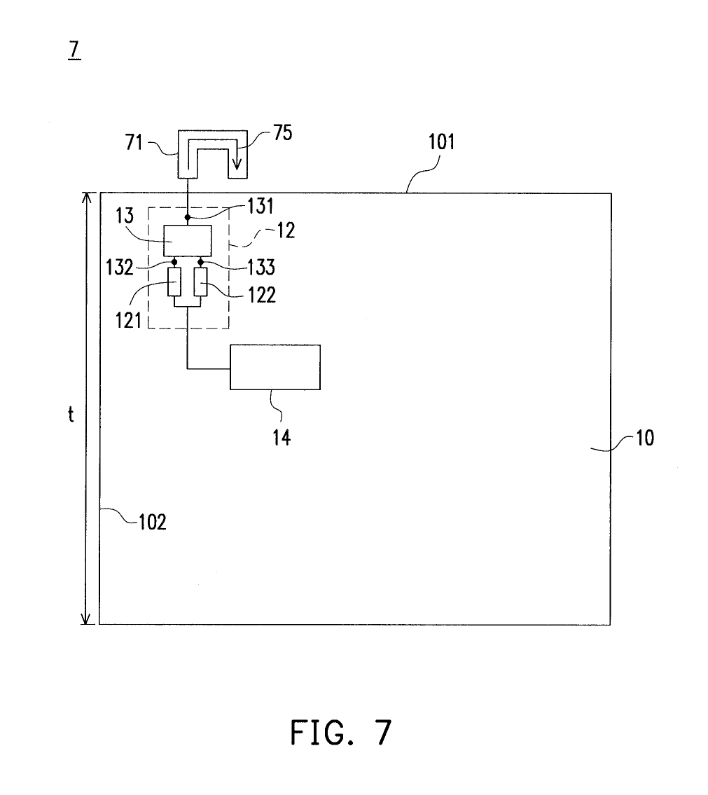

FIG. 7 is a structural schematic diagram showing a communication device according to the third embodiment of the present invention. In the third embodiment, a communication device 7 has an antenna element 71 which is an inverted U-shaped metal sheet and includes a current path 75. Accordingly, the current path 75 may have two bends. The rest of the structure of the communication device 7 is the same as or similar to the first embodiment (i.e., the communication device 1 illustrated in FIG. 1) and will not be repeatedly described. The third embodiment has the similar structure to the first embodiment, and thus, the third embodiment can also achieve an effect similar to the first embodiment.

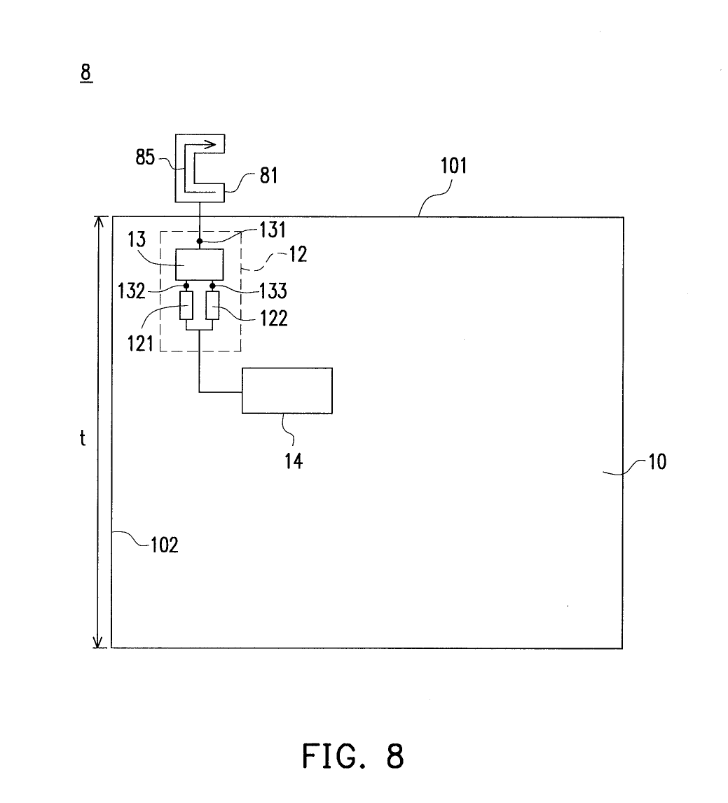

FIG. 8 is a structural schematic diagram showing a communication device according to the fourth embodiment of the present invention. In the fourth embodiment, a communication device 8 has an antenna element 81 which is a C-shaped metal sheet and includes a current path 85. The rest of the structure of the communication device 8 is the same as or similar to the first embodiment (i.e., the communication device 1 illustrated in FIG. 1) and will not be repeatedly described. The fourth embodiment has the similar structure to the first embodiment, and thus, the fourth embodiment can also achieve an effect similar to the first embodiment.

In view of the foregoing, the present invention provides a communication device having an adjustable ground plane antenna element. The ground plane antenna element is formed by the unsymmetrical dipole antenna structure, and the unsymmetrical dipole antenna structure is formed by the antenna element and the ground element in the communication device. In addition, the longest current path of the antenna element is less than 0.3 times the edge length of the ground element or less than 0.15 times the wavelength of the lowest frequency of the operation band. In other words, the current path of the antenna element is much less than a quarter wavelength required by a typical antenna element. Meanwhile, the communication device may further utilize the adjustable design of the circuit module to achieve the multi-band operation with the condition where the antenna element is maintained in the small size so as to solve the issue that the space available for designing an antenna element is very limited.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A communication device, comprising:
a ground element, having a first edge and a second edge, wherein the first edge is substantially perpendicular to the second edge; and
an antenna element, disposed adjacent to the first edge of the ground element and coupled to a circuit module, wherein the circuit module comprises at least two reactive circuits so as to allow the antenna element to be selectively operated in a first band or a second band, and the first band is different from the second band,
wherein the antenna element and the ground element form an unsymmetrical dipole antenna structure, and a longest current path length of the antenna element is less than 0.3 times a length of the second edge.

2. The communication device according to claim 1, wherein the longest current path length of the antenna element is less than 0.15 times a wavelength of a lowest frequency of the first band.

3. The communication device according to claim 1, wherein the longest current path length of the antenna element is less than 0.15 times a wavelength of a lowest frequency of the second band.

4. The communication device according to claim 1, wherein the antenna element is substantially a rectangular metal sheet.

5. The communication device according to claim 1, wherein the antenna element is substantially an inverted L-shaped metal sheet, and comprises a current path having at least one bend.

6. The communication device according to claim 1, wherein the antenna element is substantially a C-shaped metal sheet, and comprises a current path having two bends.

7. The communication device according to claim 1, wherein the antenna element is substantially an inverted U-shaped metal sheet, and comprises a current path having two bends.

8. The communication device according to claim 1, wherein the at least two reactive circuits comprise a first reactive circuit and a second reactive circuit, wherein when the antenna element is coupled to the first reactive circuit, the antenna element is operated in the first band, and when the antenna element is coupled to the second reactive circuit, the antenna element is operated in the second band.

9. The communication device according to claim 8, wherein the circuit module further comprises:
a switching circuit, having a first terminal, second terminal and a third terminal, wherein the first terminal of the switching circuit is coupled to the antenna element, the second terminal of the switching circuit is coupled to the first reactive circuit, the third terminal of the switching circuit is coupled to the second reactive circuit, and the first terminal is selectively conducted to the second terminal or the third terminal.

10. The communication device according to claim 9, further comprising:
a communication module, coupled to the first reactive circuit and the second reactive circuit.

11. The communication device according to claim 1, wherein the antenna element and the ground element are formed on a dielectric substrate.

12. The communication device according to claim 1, wherein the first band approximately covers 704 MHz˜960 MHz, and the second band approximately covers 1710 MHz˜2690 MHz.
